(19) United States
(12) Patent Application Publication
(10) Pub. No.: US 2006/0256552 A1
(43) Pub. Date: Nov. 16, 2006

(54) Circuit for driving and monitoring a light signal

(75) Inventor: Rudolf Temming, Konigslutter (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/433,146

(22) Filed: May 12, 2006

(30) Foreign Application Priority Data
May 12, 2005 (DE) 10 2005 023 295.7

(51) Int. Cl. F21L 4/00

(52) U.S. Cl. 362/157; 362/800; 362/802

(57) ABSTRACT

A circuit for driving and monitoring a light signal, in particular an LED signal, has an actuating part for outputting a process voltage, and a signal transmitter for setting current windows for daytime operation and nighttime operation. In order to achieve a high degree of independence between the circuit and variable parameters, in particular the power consumption of the lighting elements, the signal transmitter has a regulator which is connected to the monitoring logic via brightness sensors for measurement of the brightness of the light signal, with the monitoring logic producing a daytime or nighttime nominal value of the current window for the regulator.

### BACKGROUND OF THE INVENTION

1. Field of the Invention:

The invention relates to a circuit for driving and monitoring a light signal, in particular an LED signal. The circuit has an actuating part that produces a process voltage and a signal transmitter for presetting current windows for daytime operation and nighttime operation.

Light signals, in particular for road and rail traffic, must be brighter during daytime operation than during nighttime operation. In the case of light signals for railroad technology, the brightness is controlled via current windows, which are predetermined by the signal transmitter. FIG. 1 shows these Current_day and Current_night current windows on a brightness/current graph. In order to achieve the desired Bright_night and Bright_day brightness, operating points AP_night and AP_day must be set, which are within specific current ranges I_N_u and I_N_o or I_D_u and I_D_o. Maintenance of the AP_night and AP_day operating points is problematic in the event of component degradations relating to the drive and monitoring circuit, or when lighting elements, in particular LEDs, are replaced by more modern elements with better light yield. Redevelopment of the electronics is generally required in cases such as these. The AP_night and AP_day operating points must be reset. Improved light yield means that it is possible to reduce the current. However, a current reduction for matching of the operating point for AP_night nighttime operation will highly probably lead to the operating point for daytime operation AP_day being above the nominal value. The matching effort for redevelopment of the drive and monitoring circuit as well as the required safety verification may result in considerable expenses. The trend shows that the light yield of light-emitting diodes is increasing continuously. In consequence, the current which needs to be transferred is becoming ever less. The current window must be monitored ever more accurately, thus increasing the susceptibility of the circuit to defects, and having a negative influence on the availability of the light signal. Furthermore, it must be remembered that the brightness of the light-emitting diodes decreases over the course of time, so that there is a risk of the desired operating points in terms of the brightness being departed from despite constant current windows.

### SUMMARY OF THE INVENTION

It is accordingly an object of the invention to provide a driver and monitor circuit for a light signal which overcomes the above-mentioned disadvantages of the heretofore-known devices and methods of this general type and which allows the signal brightness for daytime and nighttime operation to become largely constant in a simple manner even in the event of component degradations and the replacement of light source elements, in particular LEDs.

With the foregoing and other objects in view there is provided, in accordance with the invention, a circuit for driving and monitoring a light signal, in particular an LED signal, comprising:

an actuating part for providing of a process voltage;

a signal transmitter connected to said actuating part, said signal transmitter setting current windows for daytime operation and nighttime operation, respectively, of the light signal; and

said signal transmitter including a regulator, one or more brightness sensors disposed to measure a brightness of the light signal, and a monitoring logic connected to said brightness sensors and said regulator, said monitoring logic producing a nominal daytime value and a nominal nighttime value, respectively, of the current window for the regulator.

Controlling the brightness results in a high degree of independence between the power of the signal transmitter and the light power of the lighting elements used. As a consequence, there is no longer any need for configuration or reengineering of the actuating part for matching to the power of the signal transmitter. The safety verification is valid for a wide power range of the signal transmitter. In addition, there is no time limit to the permissible time of use of the lighting elements, since aging-dependent brightness decreases are effectively regulated out.

A signal box is normally required for the signal drive. The high signal voltage is converted in the signal box to a low voltage for the signal transmitter by means of signal transformers, in order to minimize the power loss which occurs in the signal cable as a result of the line resistance. The signal transformer has a plurality of taps. In consequence, the voltage losses in the signal cable can be compensated for by configuration. This distance-dependent adjustment is no longer necessary because of the brightness control, so that there is no need for a signal box in the present form. The existing signal cables can still be used, irrespective of their length.

The reference variable for brightness control is formed by means of brightness sensors which measure the actual brightness of the lighting elements. A daytime and nighttime nominal value of the regulator current is produced by means of the monitoring logic, in order to regulate the nominal brightness.

In accordance with an added feature of the invention, the switching time between daytime and nighttime operation is preset by the actuating part. This can be achieved, for example, by means of a different waveform of the process voltage which is produced by the actuating part.

In accordance with an alternative possibility, decentralized daytime/nighttime switching can be provided. A sensor for measurement of the environmental (i.e., ambient) brightness of the light signal is in this case used to set the switching time. The brightness of the light signal is optimally matched to the location of the signal, avoiding the complexity for the additional provision of a nighttime voltage. The signal transmitter can be configured or designed in such a way that it optimally regulates the light strength of the signal as a function of the brightness of the signal environment.

In accordance with an additional feature of the invention, the regulator is not designed to be signaling-technology secure—in contrast to the monitoring logic and the brightness sensors for measurement of the signal brightness and, possibly, the sensors for measurement of the environmental brightness. The brightness is thus monitored in a safety-relevant manner, for example by means of duplication of the monitoring logic and of the connected brightness sensors. However, the monitoring logic and the associated brightness sensors can also be used, in one simple embodiment, for non-safety-relevant signal circuits. The functionality is fully maintained. Graduated safety is also feasible, wherein the monitoring logic together with the sensors is used in only duplicated form.

In accordance with a further feature of the invention, the regulator is connected to an AC/DC converter, which converts the fluctuating process voltage to a lower, constant DC voltage. The regulation principle is in this case based on the idea of the current and voltage for the lighting elements being adjusted via this conversion process in such a manner that the actual brightness corresponds to the nominal brightness of the light signal. If required, pulse-width modulation can also be interposed. There is no need for any signal transformer for conversion of the high signal voltage to a low voltage for the signal transmitter, as a result of the use of a more compact and lighter-weight AC/DC converter.

In accordance with again another feature of the invention, a logic is provided for daytime/nighttime switching, which produces the nominal value and a reference voltage for the monitoring of the operating point for daytime and nighttime operation, respectively, with the reference voltage and the output signal from the brightness sensors which corresponds to the actual brightness value of the light signal being compared by means of a comparator, whose output signal is logically linked with a high or low level, which is associated with the current-flow state of the monitoring logic of a signal by means of an AND gate, with a switch being switched on and the actuating part signaling a fault state in the situation wherein the signal brightness does not correspond to the predetermined current window. The daytime/nighttime switching is preferably designed for central daytime/nighttime switching according to claim 2, and/or decentralized daytime/nighttime switching according to claim 3.

Since the information as to whether a signal transmitter has been switched on correctly is available in the monitoring logic, this information is made available, in accordance with a further feature of the invention, as an output for the connection of a train-influencing or train signaling device.

Other features which are considered as characteristic for the invention are set forth in the appended claims.

Although the invention is illustrated and described herein as embodied in a circuit for driving and monitoring a light signal, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagram with a brightness/current graph; and

FIG. 2 is a schematic illustrating the fundamental principle of a circuit for driving and monitoring a light signal.

### DESCRIPTION OF THE PREFERRED EMBODIMENTS

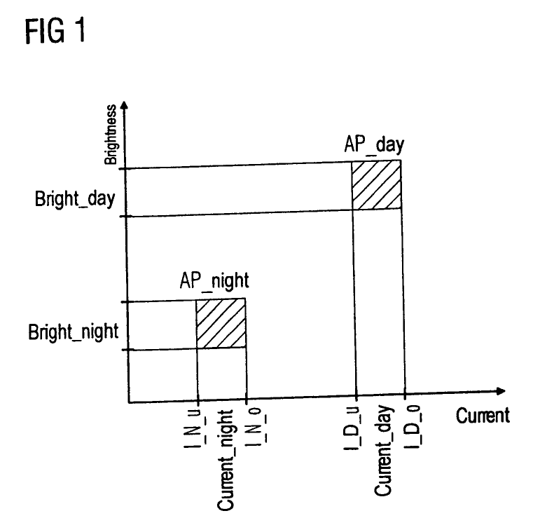

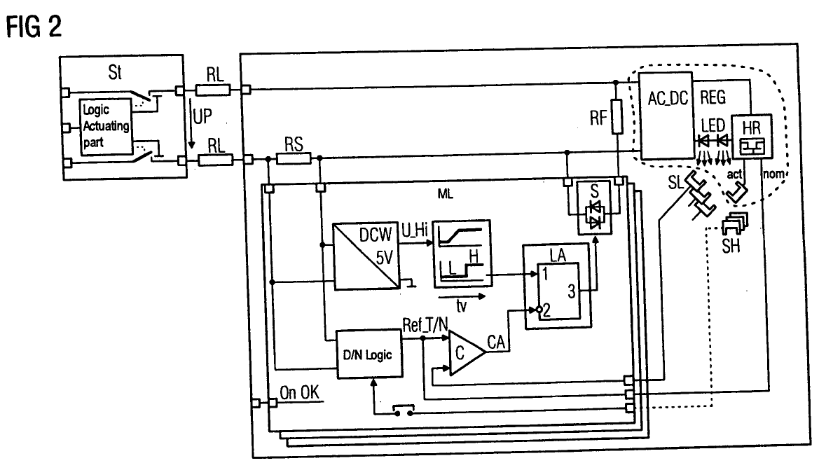

Referring now to the figures of the drawing in detail, the position of the AP_night and AP_day operating points shown in FIG. 1 are set and monitored by way of the circuit shown in FIG. 2. The circuit comprises an actuating part St and a signal transmitter Sign, wherein case the signal transmitter Sign is intended to comprise both the optics and the electronics in the signal. Light-emitting diodes LED are provided as lighting elements. The LEDs are included in a control loop REG for regulation of their brightness. This regulation is not designed to be signaling-technology safe while, in contrast, the monitoring of the brightness is carried out in a signaling-technology safe manner by means of a plurality of monitoring logic devices ML, likewise with a plurality of brightness sensors SL connected to them, which measure the actual brightness Bact of the LEDs. The current and voltage of the LEDs can be adjusted by means of the following control processes:

An AC/DC converter AC_DC converts a high fluctuating process voltage UP which is produced by the actuating part St, to a low constant DC voltage, with the brightness being regulated with low losses, for example on the basis of pulse-width modulation.

The AC/DC converter AC_DC converts the high fluctuating process voltage UP to a low DC voltage in such a manner that the nominal brightness Bnom corresponds to the actual value Bact.

The monitoring logic ML together with the voltage converter DCW uses the voltage drop across a resistor RS to produce a constant voltage U_Hi, for example of 5 V. A signal E is produced from this voltage U_Hi and, once the process voltage UP has been switched on by the actuating part St, changes from low L to high H in a delay time tv. Logic for the daytime/nighttime switching D/N-logic produces a reference voltage Ref_T/N for a downstream comparator C, whose second input has the actual brightness signal Bact from the brightness sensors SL applied to it. The output signal CA from the comparator C is logically linked by means of an AND gate LA with the signal E in such a manner that, in the event of a fault, that is to say the brightness does not correspond to the AP_night or AP_day operating point, a switch S is switched on, and a high current and thus a fault state are signaled to the actuating part St via a resistor RF. The actuating part St can then initiate appropriate failure processing.

In addition to forming the reference value Ref_D/N for the monitoring of the AP_night and AP_day operating points, the logic for daytime/nighttime switching DN-logic also forms the nominal value Bnom for brightness regulation HR. Two operating modes are possible in this case, specifically decentralized daytime/nighttime switching or central daytime/nighttime switching. In the case of decentralized daytime/nighttime switching, sensors SH measure the brightness of the environment. The logic for daytime/nighttime switching DN-logic uses this to form the nominal value Bnom for brightness regulation HR and the reference value Ref_D/N for monitoring the AP_night and AP_day operating point. The signal brightness is optimally matched to the signal location. In the case of central daytime-nighttime switching, the information as to whether the signal transmitter Sign is intended to operate at the AP_day or AP_night operating point is transmitted from the actuating part St to the signal transmitter Sign. For this purpose, the actuating part St sends a continuous AC voltage UP when the AP_day operating point is to be set, and an AC voltage wherein every N-th cycle is missing when the AP_night operating point is to be set.

The signal transmitter Sign can be driven by the actuating part St in the power range from 5 W to 50 W by way of example, without any need to change the configuration data of the actuating part St. A process voltage UP of 200 V AC results in a current range from 25 mA to 250 mA on the primary side. If the regulation REG is implemented in such a way that a current of more than 40 mA always flows on the primary side, and the resistor RF is of such a magnitude that a current of more than 1 A flows in the event of a fault, then signal switching which is insensitive to disturbances can be provided on the basis of the large current separations. If the actuating part St measures a current of less than 40 mA, then the signal transmitter Sign is switched off, while current is flowing correctly in the signal transmitter Sign in a current range from 40 mA to 250 mA, and a fault has occurred if the current is more than 1 A. A line resistance RL of 140 ohms results in a power loss in the cable of 0.23 W at 40 mA and 8.75 W at 250 mA.

One output On_OK of the signal transmitter Sign can be used for the connection of a train-influencing device, since the monitoring logic ML provides the information about the current-flow state.

The invention is not restricted to the exemplary embodiment specified above. In fact, a number of variants are feasible, which also make use of fundamentally different types of embodiment of the features of the invention.

This application claims the priority, under 35 U.S.C. §119, of German patent application No. 10 2005 023 295.7, filed May 12, 2005; the entire disclosure of the prior application is herewith incorporated by reference.

I claim:

1. A circuit for driving and monitoring a light signal, comprising:
an actuating part for providing of a process voltage;
a signal transmitter connected to said actuating part, said signal transmitter setting current windows for daytime operation and nighttime operation, respectively, of the light signal; and
said signal transmitter including a regulator, one or more brightness sensors disposed to measure a brightness of the light signal, and a monitoring logic connected to said brightness sensors and said regulator, said monitoring logic producing a nominal daytime value and a nominal nighttime value, respectively, of the current window for the regulator.

2. The circuit according to claim 1, wherein the light signal is an LED light signal.

3. The circuit according to claim 1, wherein said actuating part includes means for presetting a switching time between daytime operation and nighttime operation.

4. The circuit according to claim 1, which comprises at least one sensor for measuring an ambient light brightness for setting a switching time between daytime operation and nighttime operation.

5. The circuit according to claim 1, wherein said regulator is not configured to be secure in terms of signaling technology, and wherein said monitoring logic and said brightness sensors are configured to be secure in terms of signaling technology.

6. The circuit according to claim 5, which further comprises at least one ambient light sensor for measuring an ambient light brightness for setting a switching time between daytime operation and nighttime operation, and wherein said ambient light sensor is configured to be secure in terms of signaling technology.

7. The circuit according to claim 1, wherein said regulator includes an AC/DC converter for converting a fluctuating process voltage to a lower DC voltage, in order to achieve an actual brightness corresponding to a nominal brightness of the light signal.

8. The circuit according to claim 7, which comprises a pulse-width modulator interposed to drive the light source to achieve the actual brightness corresponding to the nominal bightness.

9. The circuit according to claim 1, wherein said monitoring logic includes a logic for daytime/nighttime switching, said logic produces the nominal value and a reference voltage for monitoring the current window for daytime and nighttime operation, respectively, a comparator comparing the reference voltage and the output signal from said brightness sensors representing the actual brightness value of the light signal, wherein an output signal of said comparator is logically linked with a high level or a low level associated with a current-flow state of said monitoring logic of a signal by way of an AND gate, and wherein a switch is switched on and said actuating part signals a fault state in a situation wherein the signal brightness does not correspond to the predetermined current window.

10. The circuit according to claim 1, wherein said monitoring logic is configured to generate a signal corresponding to a current-flow state of said signal transmitter and to act on a train-influencing device.
